(19) United States
(12) Patent Application Publication
(10) Pub. No.: US 2007/0104392 A1
(43) Pub. Date: May 10, 2007

(54) Image enlarging method and TV wall using the same

(75) Inventor: Chia-Cheng Huang, Longci Township (TW)

Correspondence Address: LADAS & PARRY, 26 WEST 61ST STREET, NEW YORK, NY, 10023, US

(73) Assignee: CHI LIN TECHNOLOGY CO., LTD.

(21) Appl. No.: 11/268,351

(22) Filed: Nov. 7, 2005

(51) Int. Cl. G06K 9/32

(52) U.S. Cl. 382/298

(57) ABSTRACT

The present invention relates to an image enlarging method and a TV wall using the same. The image enlarging method is used for enlarging a first image into a second image in a non-integer multiple. In order to supply the lacking pixels, the method utilizes Digital Differential Analysis (DDA) algorithm-based process or equally dividing intervals. As a result, the distortion is improved, and the black area resulted from the lacking pixels in the conventional method will not occur.

### BACKGROUND OF THE INVENTION

1. Field of the invention

The present invention relates to an image enlarging method and a TV wall using the same, particularly to a method for enlarging an image in non-integer multiple and a TV wall using the same.

2. Description of the Related Art

The TV wall is constituted by plural display devices for displaying an enlarged image, which is usually applied as an advertising billboard. The image adopted in conventional TV wall is an analog image, which has the shortcomings of analog decay, color shift and low resolution (usually under 1024*768). Therefore, in order to raise the resolution of the displayed image and make the colors in the display devices more even, there is a trend of using digital enlarging system.

FIGS. 1a and 1b show a conventional method for enlarging a digital image, wherein FIG. 1a shows a source image 10 to be enlarged, and FIG. 1b shows an enlarged image 20 that is derived from enlarging the source image 10 in four (2*2) multiple and displayed in the TV wall constituted by four display devices 21, 22, 23, 24. In the following example, the resolutions of the source image 10 and single display device of the TV wall are both 1024*768. The resolution of 1024*768 means that one image has 1024 pixels in the horizontal direction (i.e. 1024 columns of pixels) and 768 pixels in the vertical direction (i.e. 768 rows of pixels). First, the source image 10 is divided into four partitions 11, 12, 13, 14, wherein the partition 11 corresponds to the display device 21, the partition 12 corresponds to the display device 22, the partition 13 corresponds to the display device 23 and the partition 14 corresponds to the display device 24.

FIG. 2 shows the definition of the coordinate of an image in the specification. As shown in FIG. 2, a first image 31 is captured from a source image 30 and is then enlarged. There are two ways for defining the parameters of capture: the first way is defining the first image 31 from initial point A (X₀, Y₀) on the upper-left corner to end point B (X_{f}, Y_{f}) on the lower-right corner; the second way is defining the first image 31 by the initial point A (X₀, Y₀), a horizontal length X₁ and a vertical length Y₁, wherein X₁=X_{f}−X₀ and Y₁=Y_{f}−Y₀.

Referring to FIGS. 1a and 1b again, in the source image 10, if the upper-left corner is the origin (0, 0) of the coordinate, the partition 11 is from (0, 0) to (511, 383), the partition 12 is from (512, 0) to (1023, 383), the partition 13 is from (0, 384) to (511, 767), and the partition 14 is from (512, 384) to (1023, 767), wherein the resolution of each partition is 512*384. In order to display the image of each partition (the resolution is 512*384) on the corresponding display device (the resolution is 1024*768), the resolution must be supplemented to 1024*768. Therefore, along the horizontal direction, each pixel is repeated once so that 1024 pixels are carried out by 512 pixels; along the vertical direction, each row of pixels is repeated once so that 768 rows of pixels are carried out by 384 rows of pixels. Finally, the transformed images of the partitions are displayed on the corresponding display devices of the TV wall so as to combine the enlarged image 20.

FIG. 3 shows an actual displayed image of the conventional method for enlarging a digital image. The enlarged image 20 displayed on the above FIG. 1b is an ideal situation. Since the display devices 21, 22, 23, 24 have frame 25, the actual displayed image on the TV wall will have distortion, as shown in FIG. 3.

To improve the distortion on full-size image derived from the conventional enlarging method, the frame 25 on the TW wall should be taken as frame of window, and some pixels of the source image 10 should be discarded. Taking FIG. 3 for example, if the frame 25 covers 10 columns of pixels and 10 rows of pixels in the enlarged image, the coordinate values of capturing the partitions 11, 12, 13, 14 should be changed. That is, the partition 11 should be changed from (0, 0) to (506, 378), the partition 12 should be changed from (517, 0) to (1023, 378), the partition 13 should be changed from (0, 389) to (506, 767), and the partition 14 should be changed from (517, 389) to (1023, 767). However, Taking the partition 11 for example, when it is displayed on the display device 21 (the resolution is 1024*768), it lacks 10 columns of pixels along the horizontal direction and 10 rows of pixels along the vertical direction if it is enlarged in a multiple of 2 along the horizontal direction and the vertical direction since the resolution of the enlarged partition 11 is 1014*758.

The conventional method for improving the above-mentioned shortcoming is to dispose the lacking pixels on the sides of the enlarged image. Taking partition 11 for example, when it is displayed on the display device 21, the lacking 10 columns of pixels along the horizontal direction are disposed on the left side without any output signal and displayed in black color. Similarly, the lacking 10 rows of pixels along the vertical direction are disposed on the topside without any output signal and are displayed in black color. Although such method can improve the distortion of image, the black areas on the sides are not desired.

Consequently, there is an existing need for a novel and improved image enlarging method and a TV wall using the same to solve the above-mentioned problem.

### SUMMARY OF THE INVENTION

One objective of the present invention is to provide an image enlarging method for enlarging a first image into a second image in a non-integer multiple. In order to supply the lacking pixels, the method utilizes Digital Differential Analysis (DDA) algorithm-based process or equally dividing intervals. As a result, the distortion is improved, and the black area resulted from the lacking pixels in the conventional method will not occur.

Another objective of the present invention is to provide a method for forming an enlarged image on a TV wall having a plurality of display devices. The method comprises the following steps:

(a) capturing a source image;

(b) dividing the source image into a plurality of first images according to the amount and disposition of the display devices and the discard of the frame between the display devices, and determining a non-integer multiple;

(c) enlarging the first images into a plurality of second images in a non-integer multiple; and

(d) displaying the second images on the corresponding display devices respectively.

Still another objective of the present invention is to provide a TV wall system comprising: a plurality of display devices, an image generating device and an image dividing and enlarging device. The display devices are arranged arrayed. The image generating device is used for providing a source image. The image dividing and enlarging device is used for dividing the source image into a plurality of first images according to the amount and disposition of the display devices and the discard of the frame between the display devices, and enlarging the first images into a plurality of second images in a non-integer multiple. The image dividing and enlarging device is connected to the display devices so as to display the second images on the corresponding display devices respectively.

### BRIEF DESCRIPTION OF THE DRAWINGS

FIGS. 1a and 1b show a conventional method for enlarging a digital image;

FIG. 2 shows the definition of the coordinate of an image in the specification;

FIG. 3 shows an actual displayed image of the conventional method for enlarging a digital image;

FIG. 4 shows an image enlarging method according to a first embodiment of the present invention;

FIG. 5 shows the image enlarging method according to example 1 of the present invention;

FIG. 6 shows an image enlarging method according to a second embodiment of the present invention;

FIG. 7 shows the image enlarging method according to example 2 of the present invention;

FIG. 8 shows an image enlarging method according to a third embodiment of the present invention;

FIG. 9 shows the image enlarging method according to example 3 of the present invention;

FIG. 10 shows a preferred embodiment of a TV wall system according to the present invention;

FIG. 11 shows a source image applied for the embodiment of FIG. 10; and

FIG. 12 shows an enlarged image applied for the embodiment of FIG. 10.

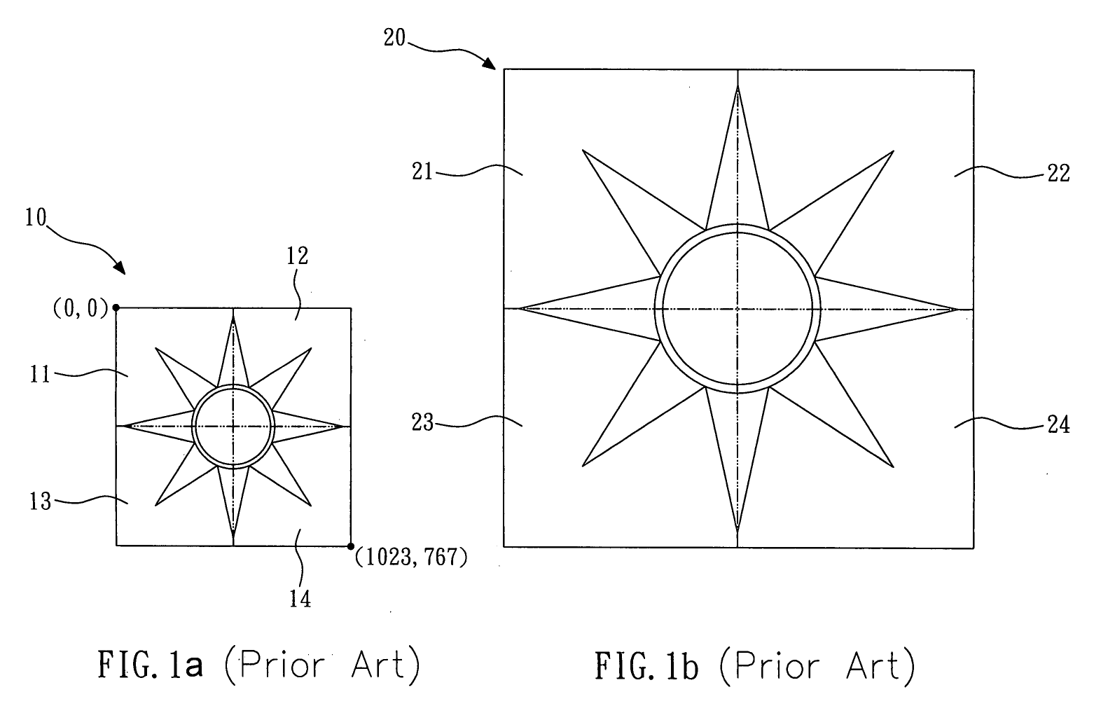

### DETAILED DESCRIPTION OF THE INVENTION

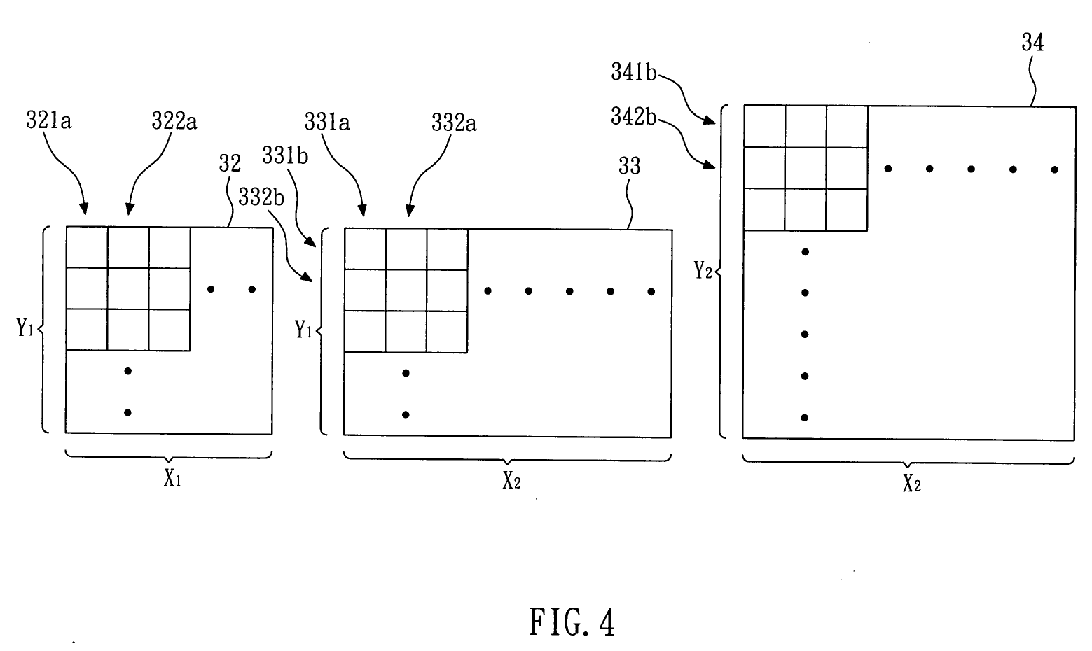

FIG. 4 shows an image enlarging method according to a first embodiment of the present invention. The image enlarging method of the embodiment is used for enlarging a first image 32 into a second image 34 in a non-integer multiple. The first image 32 is constituted by a plurality of arrayed first pixels, wherein the first image 32 has plural column first pixels arranged in X₁ columns along a first coordinate axis direction (for example, horizontal direction). That is, the first image 32 has X₁ columns of the first pixels. The first image 32 has plural row first pixels arranged in Y₁. rows along a second coordinate axis direction (for example, vertical direction). That is, The first image 32 has Y₁. rows of the first pixels. The second image 34 is constituted by a plurality of arrayed second pixels, wherein the second image 34 has plural column second pixels arranged in X₂ columns along the first coordinate axis direction (for example, horizontal direction). That is, the second image 34 has X₂ columns of the second pixels. The second image 34 has plural row second pixels arranged in Y₂ rows along the second coordinate axis direction (for example, vertical direction). That is, the second image 34 has Y₂ rows of the second pixels. The method comprises the following steps:

(a) capturing the first pixels of the first image 32;

(b) determining the X₂ columns of the second pixels of the second image 34 according to the X₁ columns of the first pixels of the first image 33 along the first coordinate axis direction by utilizing a Digital Differential Analysis (DDA) algorithm-based process so as to form a temporary image 33. The temporary image 33 has plural column temporary pixels arranged in X₂ columns along the first coordinate axis direction. That is, the temporary image 33 has X₂ columns of temporary pixels. The temporary image 33 has plural row temporary pixels arranged in Y₁, rows along the second coordinate axis direction. That is, the temporary image 33 has Y₁, rows of temporary pixels; and

(c) determining the rows of the second pixels of the second image according to the rows of the temporary pixels along the second coordinate axis direction by utilizing a DDA algorithm-based process so as to form the second image.

In the embodiment, DDA algorithm-based process is used in steps (b) and (c), is carried out by accumulation and subtraction, and shows the next data when the carry situation happens. Taking step (b) for example, the carry condition is X₂, the temporary value is Pₓ (x=1,2,3, . . . ), the last temporary value is Pₓ₋₁, and each DDA cycle executes Pₓ=Pₓ₋₁+X₁ once. After execution, if Pₓ<X₂, the output data is equal to the last data; otherwise, the output data is the next data and Pₓ is set to be Pₓ=Pₓ−X₂.

Therefore, the step (b) comprises the following steps:

(b1) equalizing a predetermined column (for example, the first column 331a) of the temporary pixels of the temporary image 33 to a corresponding column (for example, the first column 321a) of the first pixels of the first image 32;

(b2) accumulating the X₁ value and a first temporary value to form a second temporary value;

(b3) determining whether or not the second temporary value is smaller than the X₂ value in order to determine a column (for example, the second column 332a) of the temporary pixels next to the predetermined column 331a of the temporary pixels of the temporary image 33;

(b4) if the second temporary value is smaller than the X₂ value, which is defined as a non-carry situation, the column 332a of the temporary pixels next to the predetermined column 331a of the temporary pixels of the temporary image 33 is equal to the predetermined column 331a of the temporary pixels of the temporary image 33, and the first temporary value is changed to the second temporary value;

(b5) if the second temporary value is larger than or equal to the X₂ value, which is defined as a carry situation, the column 332a of the temporary pixels next to the predetermined column 331a of the temporary pixels of the temporary image 33 is equal to the column 322a of the first pixels next to the corresponding column 321a of the first pixels of the first image 32, then the X₂ value is subtracted from the second temporary value to form a third temporary value, and the first temporary value is changed to the third temporary value; and

(b6) repeating the steps (b3) to (b5).

Similarly, the step (c) comprises the following steps:

(c1) equalizing a predetermined row (for example, the first row 341b) of the second pixels of the second image 34 to a corresponding row (for example, the first row 331b) of the temporary pixels of the temporary image 33;

(c2) accumulating the Y₁, value and a fourth temporary value to form a fifth temporary value;

(c3) determining whether or not the fifth temporary value is smaller than the Y₂ value in order to determine a row (for example, the second row 342b) of the second pixels next to the predetermined row 341b of the second pixels of the second image 34;

(c4) if the fifth temporary value is smaller than the Y₂ value, which is defined as a non-carry situation, the row 342b of the second pixels next to the predetermined row 341b of the second pixels of the second image 34 is equal to the predetermined row 341b of the second pixels of the second image 34, and the fourth temporary value is changed to the fifth temporary value;

(c5) if the fifth temporary value is larger than or equal to the Y₂ value, which is defined as a carry situation, the row 342b of the second pixels next to the predetermined row 341b of the second pixels of the second image 34 is equal to the row (for example, the second row 332b) of the temporary pixels next to the corresponding row 331b of the temporary pixels of the temporary image 33, then the Y₂ value is subtracted from the fifth temporary value to form a sixth temporary value, and the fourth temporary value is changed to the sixth temporary value; and

(c6) repeating the steps (c3) to (c5).

### EXAMPLE 1

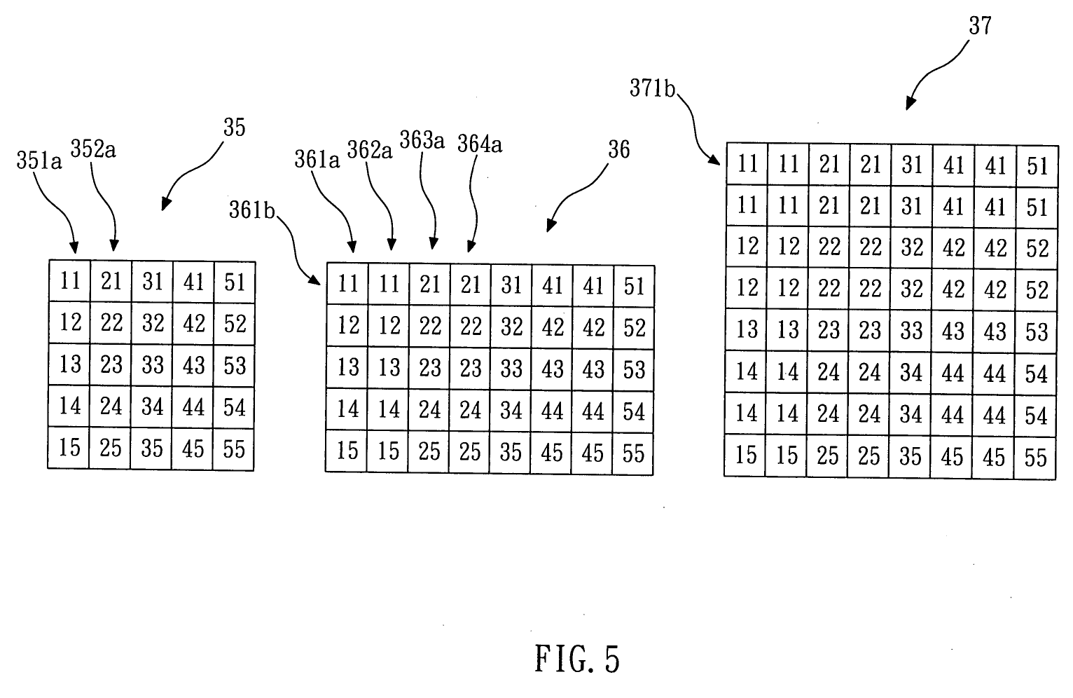

FIG. 5 shows the image enlarging method according to example 1 of the present invention. The image enlarging method of example 1 is used for enlarging a first image 35 into a second image 37 in a non-integer multiple. The first image 35 is constituted by a plurality of arrayed first pixels, wherein the first image 35 has 5 columns of the first pixels along the horizontal direction, and the first image 35 has 5 rows of the first pixels along the vertical direction. The second image 37 is constituted by a plurality of arrayed second pixels, wherein the second image 37 has 8 columns of the second pixels along the horizontal direction, and the second image 37 has 8 rows of the second pixels along the vertical direction.

The method comprises the following steps. First, the first image 35 is captured from a source image (not shown). Then, a DDA algorithm-based process is utilized to fill the total length (8 columns) along the horizontal direction of the second image 37 with the 5 columns of the first pixels of the first image 35 so as to form a temporary image 36. The execution of the DDA algorithm-based process is as follows.

First, the first column of the temporary pixels 361a of the first column of the temporary image 36 is equal to the first column of the first pixels 351a of the first image 35. That is, the temporary pixels 361a of the first column of the temporary image 36 are same with the first pixels 351a of the first column of the first image 35 respectively. Then, the DDA algorithm-based process is executed to obtain the results as shown in table 1 so as to determine the pixels after the first column.

TABLE 1
the result of the execution of the DDA algorithm-based process

| DDA cycle (x) | Length of image | Temporary value | carry |
|---|---|---|---|
| 1 | 5 | 5 + 0 = 5 | 0 |
| 2 | 5 | 5 + 5 − 8 = 2 | 1 |
| 3 | 5 | 5 + 2 = 7 | 0 |
| 4 | 5 | 5 + 7 − 8 = 4 | 1 |
| 5 | 5 | 5 + 4 − 8 = 1 | 1 |
| 6 | 5 | 5 + 1 = 6 | 0 |
| 7 | 5 | 5 + 6 − 8 = 3 | 1 |

The result of table 1 is obtained by the following steps. The temporary pixels 362a of the second column are illustrated, and they correspond to the first cycle (x=1) of the DDA. First, a first temporary value Pₓ=0 is provided. Then, a second temporary value (5) is obtained by accumulating the X₁ value (X₁=5) and the first temporary value Pₓ (Pₓ=0). Since the second temporary value (5) is smaller than the carry condition X₂ (X₂=8), it is defined as non-carry situation (0). Therefore, the temporary pixels 362a of the second column of the temporary image 36 are equal to the temporary pixels 361a of the first column of the temporary image 36, and the first temporary value Pₓ is changed to 5.

Then, the second cycle (x=2) of the DDA are proceeded. A second temporary value (10) is obtained by accumulating the X₁ value (X₁=5) and the first temporary value Pₓ (Pₓ=5). Since the second temporary value (10) is larger than the carry condition X₂ (X₂=8), it is defined as carry situation (1). Therefore, the temporary pixels 363a of the third column of the temporary image 36 are equal to the first pixels of the next column of the first image 35, i.e., the first pixels 352a of the second column. Then the X₂ value (X₂=8) is subtracted from the second temporary value (10) to obtain a third temporary value (2), and the first temporary value Pₓ is changed to 2.

Then, the third cycle (x=3) of the DDA is proceeded. A second temporary value (7) is obtained by accumulating the X₁ value (X₁=5) and the first temporary value Pₓ (Pₓ=2). Since the third temporary value (7) is smaller than the carry condition X₂ (X₂=8), it is defined as non-carry situation (0). Therefore, the temporary pixels 364a of the fourth column of the temporary image 36 are equal to the temporary pixels 363a of the third column of the temporary image 36, and the first temporary value Pₓ is changed to 7.

Similarly, the other cycles of the DDA are proceeded so as to fill 8 columns of pixels with 5 columns of the first image 35, and the temporary image 36 is obtained. The temporary image 36 has 8 columns of temporary pixels along the vertical direction, and the temporary image 33 has 5 rows of temporary pixels along the horizontal direction.

Then, the DDA algorithm-based process is executed again to fill the total length (8 rows) along the vertical direction of the second image 37 with the 5 columns of the temporary pixels of the temporary image 36 so as to form the second image 37. The method is as follows.

First, the first row of the second pixels 371b of the second image 37 is equal to the first row of the temporary pixels 361b of temporary image 36. That is, the second pixels 371b of the first row of the second image 37 are the same as the temporary pixels 361b of the first row of the temporary image 36. Then, the DDA algorithm-based process is executed according the above-mentioned way to determine the pixels after the first row so as to form the second image 37. Finally, the second image 37 is displayed.

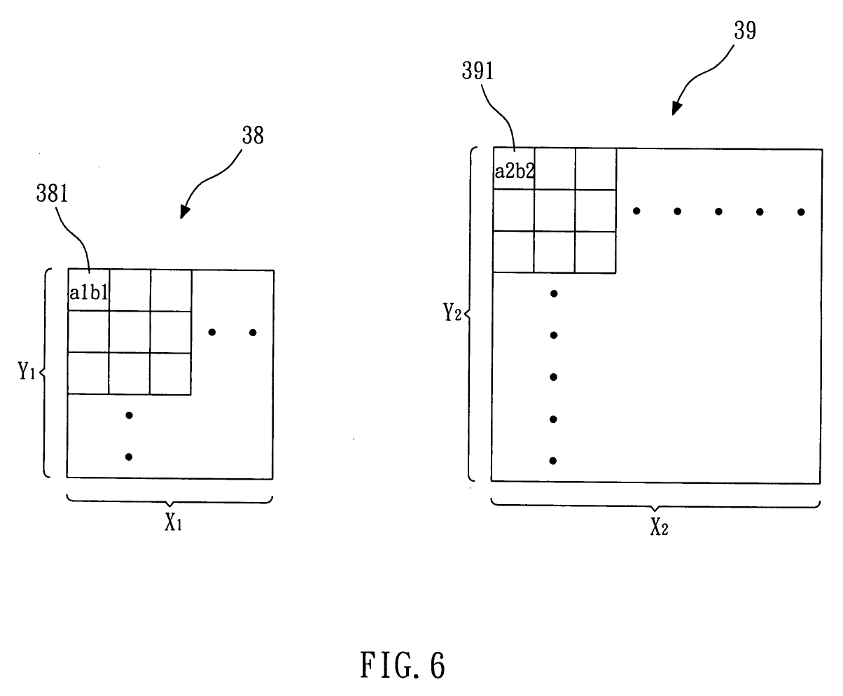

FIG. 6 shows an image enlarging method according to a second embodiment of the present invention. The image enlarging method of the embodiment is used for enlarging a first image 38 into a second image 39 in a non-integer multiple. The first image 38 is constituted by a plurality of arrayed first pixels, wherein the first image 38 has X₁ first pixels along a first coordinate axis direction (for example, horizontal direction), and the first image 38 has Y₁. first pixels along a second coordinate axis direction (for example, vertical direction). The second image 39 is constituted by a plurality of arrayed second pixels, wherein the second image 39 has X₂ second pixels along the first coordinate axis direction (for example, horizontal direction), and the second image 39 has Y₂ second pixels along the second coordinate axis direction (for example, vertical direction). The method comprises the following steps:

(a) capturing the first pixels of the first image 38, each first pixel is defined as a first coordinate value (for example, a₁), a second coordinate value (for example, b₁) and a first pixel value (for example, the RGB information), wherein the first coordinate value (for example, a₁) corresponds to the first coordinate axis direction, and the second coordinate value (for example, b₁) corresponds to the second coordinate axis direction. For example, the coordinate value of the first first pixel 381 is (11), that is, a₁=1, b₁=1. The coordinate values of other first pixels are increased in sequence;

(b) determining the first coordinate values (for example, a₂) of the second pixels of the second image 39 according to the first coordinate values (for example, a₁) of the first pixels by utilizing a DDA algorithm-based process;

(c) determining the second coordinate values (for example, b₂) of the second pixels of the second image 39 according to the second coordinate values (for example, b₁) of the first pixels by utilizing a DDA algorithm-based process; and

(d) specifying the second pixel values of the second pixels according to the first coordinate values (for example, a₂) and the second coordinate values (for example, b₂) of the second pixels, wherein the second pixel values of the second pixels are the same as the first pixel values of the first pixels having the same first coordinate values (for example, a₁) and the second coordinate values (for example, b₁) with the second pixels.

In the embodiment, the DDA algorithm-based process utilized in the steps (b) and (c) is same as that in the first embodiment. The difference between the embodiment and the first embodiment is that the second pixels in the second image 39 are designated with a first coordinate values and a second coordinate values, and the second pixels show the same information as the first pixels which have same coordinate values as the second pixels.

The step (b) of the embodiment comprises the following steps:

(b1) equalizing a first coordinate value a₂ of a predetermined second pixel (for example, the first second pixel 391) of the second image 39 to a first coordinate value a₁, of a corresponding first pixel (for example, the first first pixel 381) of the first image 38;

(b2) accumulating the X₁ value and a first temporary value to form a second temporary value;

(b3) determining whether or not the second temporary value is smaller than the X₂ value in order to determine a first coordinate value a₂′ of a second pixel next to the predetermined second pixel;

(b4) if the second temporary value is smaller than the X₂ value, which is defined as non-carry situation, the first coordinate value a₂′ of the second pixel next to the predetermined second pixel is equal to the first coordinate value a₂ of the predetermined second pixel, and the first temporary value is changed to the second temporary value;

(b5) if the second temporary value is larger than or equal to the X₂ value, which is defined as carry situation, the first coordinate value a₂′ of the second pixel next to the predetermined second pixel is equal to the first coordinate value a₂ of the predetermined second pixel with an increment of 1, then the X₂ value is subtracted from the second temporary value to form a third temporary value, and the first temporary value is changed to the third temporary value; and

(b6) repeating the steps (b3) to (b5).

Similarly, the step (c) comprises the following steps:

(c1) equalizing a second coordinate value b₂ of a predetermined second pixel (for example, the first second pixel 391) of the second image 39 to a second coordinate value b₁, of a corresponding first pixel (for example, the first first pixel 381) of the first image 38;

(c2) accumulating the Y₁. value and a fourth temporary value to form a fifth temporary value;

(c3) determining whether or not the fifth temporary value is smaller than the Y₂ value in order to determine a second coordinate value b₂′ of a second pixel next to the predetermined second pixel;

(c4) if the fifth temporary value is smaller than the Y₂ value, which is defined as non-carry situation, the second coordinate value b₂′ of the second pixel next to the predetermined second pixel is equal to. the second coordinate value b₂ of the predetermined second pixel, and the fourth temporary value is changed to the fifth temporary value;

(c5) if the fifth temporary value is larger than or equal to the Y₂ value, which is defined as carry situation, the second coordinate value b₂′ of the second pixel next to the predetermined second pixel is equal to the second coordinate value b₂ of the predetermined second pixel with an increment of 1, and then the Y₂ value is subtracted from the fifth temporary value to form a sixth temporary value, and the fourth temporary value is changed to the sixth temporary value; and

(c6) repeating the steps (c3) to (c5).

### EXAMPLE 2

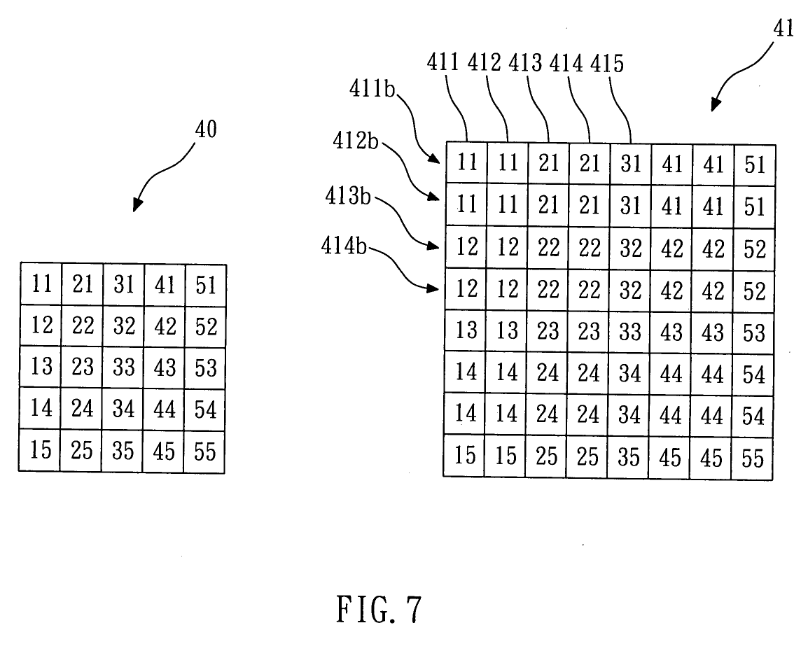

FIG. 7 shows the image enlarging method according to example 2 of the present invention. The image enlarging method of example 2 is used for enlarging a first image 40 into a second image 41 in a non-integer multiple. The first image 40 is constituted by a plurality of arrayed first pixels, wherein the first image 40 has 5 first pixels along the horizontal direction, and the first image 40 has 5 first pixels along the vertical direction. The second image 41 is constituted by a plurality of arrayed second pixels, wherein the second image 41 has 8 second pixels along the horizontal direction, and the second image 41 has 8 second pixels along the vertical direction.

The method comprises the following steps. First, capturing the first pixels of the first image 40. Then, each first pixel is defined as a first coordinate value a₁, and a second coordinate value b₁. Taking the first column for example, the pixels from top to bottom are: 11, 12, 13, 14, 15 respectively. Taking the first row for example, the pixels from left to right are: 11, 21, 31, 41, 51 respectively.

Then, the DDA algorithm-based process is executed to determine the coordinate values of the second pixels of the first row 411b of the second image 41 by utilizing the relationship between 5 and 8. The method is as follows.

First, equalizing the first coordinate value and the second coordinate value of the first second pixel 411 of the second image 41 to the first coordinate value and the second coordinate value of a corresponding first first pixel of the first image 40. That is, the first second pixel 411 of the second image 41 is defined as (11), the first coordinate values of the second pixels of the first column of the second image 41 are 1, and the second coordinate values of the second pixels of the first row of the second image 41 are 1.

In the first row 411b of the second image 41, the coordinate value of the first second pixel 411 is (11). Then, the DDA algorithm-based process is executed to obtain the results as shown in table 1 so as to determine the first coordinate values of the pixels after the first second pixel 411 in the same row.

The second second pixel 412 of the first row 411b is illustrated, and it corresponds to the first cycle (x=1) of the DDA. First, a first temporary value Pₓ=0 is provided. Then, a second temporary value (5) is obtained by accumulating the X₁ value (X₁=5) and the first temporary value Pₓ (Pₓ=0). Since the second temporary value (5) is smaller than the carry condition X₂ (X₂=8), it is defined as non-carry situation (0). Therefore, the first coordinate value of the second second pixel 412 maintains the first coordinate value (1) of the last second pixel (i.e., the first second pixel 411), and the first temporary value Pₓ is changed to 5. Accordingly, the coordinate value of the second second pixel 412 is (11).

Then, determining the third second pixel 413 which corresponds the second cycle (x=2) of the DDA. A second temporary value (10) is obtained by accumulating the X₁ value (X₁=5) and the first temporary value Pₓ (Pₓ=5). Since the second temporary value (10) is larger than the carry condition X₂ (X₂=8), it is defined as carry situation (1). Therefore, the first coordinate value of the third second pixel 413 is equal to that of the second second pixel 412 with an increment of 1. Accordingly, the coordinate value of the third second pixel 413 is (21). Then the X₂ value (X₂=8) is subtracted from the second temporary value (10) to obtain a third temporary value (2), and the first temporary value Pₓ is changed to 2.

Similarly, from the table 1, the third cycle (x=3) of the DDA is defined as non-carry situation (0). Therefore, the coordinate value of the fourth second pixel 414 is (21). Then, in the fourth cycle (x=4) of the DDA, carry situation happens. Therefore, the coordinate value of the fifth second pixel 415 is (31). The other cycles of the DDA are repeated in the same way until the coordinate values of the second pixels of the first row 411b are determined.

Then, the DDA algorithm-based process is executed to determine the coordinate values of the second pixels of the second row 412b of the second image 41 by utilizing the relationship between 5 and 8. The method is as follows. From table 1, the second row 412b of the second pixels of the second image 41 correspond to the first cycle (x=1) of the DDA, which is defined as non-carry situation. Therefore, the coordinate values of the second pixels of the second row 412b are equal to that of the first row 411b.

From table 1, the third row 413b of the second pixels of the second image 41 corresponds to the second cycle (x=2) of the DDA, which is defined as a carry situation. Therefore, the second coordinate values of the second pixels of the third row 413b are equal to those of the second row 412b with an increment of 1. Then, the fourth row 414b of the second pixels of the second image 41 corresponds to the third cycle (x=3) of the DDA, which is defined as non-carry situation. Therefore, the coordinate values of the second pixels of the fourth row 414b are equal to those of the third row 411b.

Finally, the second pixel values of the second pixels according to the first coordinate values a₂ and the second coordinate values b₂ of the second pixels are specified, wherein the second pixel values of the second pixels are the same as the first pixel values of the first pixels having the same first coordinate values a₁, and the second coordinate values b₁, with the second pixels. For example, the second pixel values of the second pixels (totally 4 second pixels) with a coordinate value of (11) in the second image 41 are equal to the first pixel value of the first pixel (totally 1 first pixel) with a coordinate value of (11) in the first image 40. The second pixel values of the second pixels (totally 2 second pixels) with a coordinate value of (31) in the second image 41 are equal to the first pixel values of the first pixel (totally 1 first pixel) with a coordinate value of (31) in the first image 40.

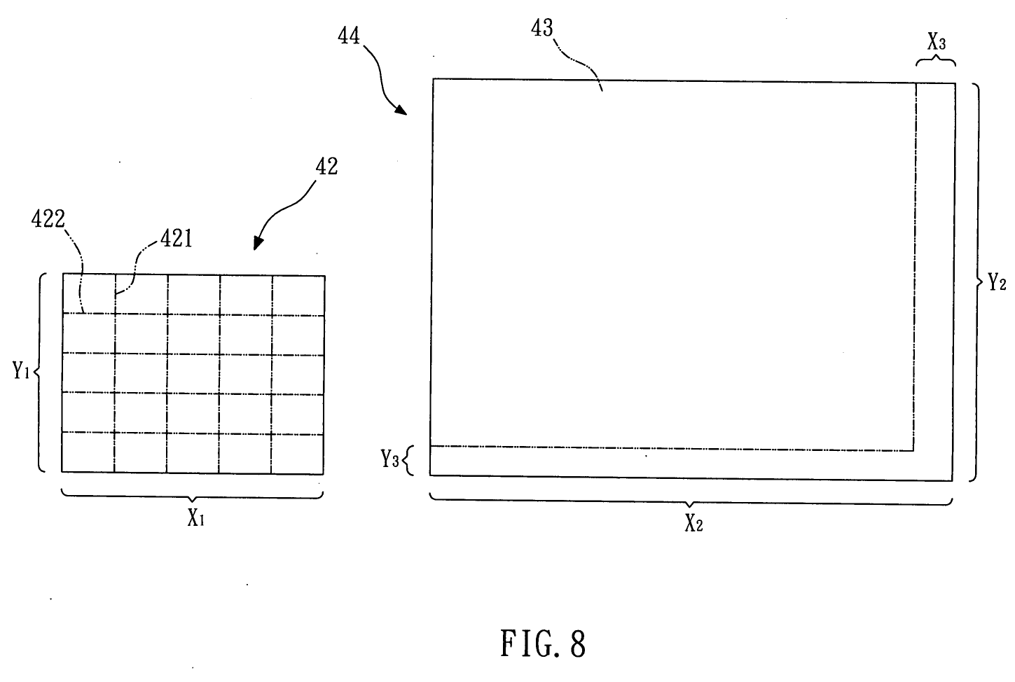

FIG. 8 shows an image enlarging method according to a third embodiment of the present invention. The image enlarging method of the embodiment is used for enlarging a first image 42 into a second image 44 in a non-integer multiple. The first image 42 is constituted by a plurality of arrayed first pixels, wherein the first image 42 has X₁ columns of the first pixels along a first coordinate axis direction (for example, horizontal direction), and the first image 42 has Y₁, rows of the first pixels along a second coordinate axis direction (for example, vertical direction). The second image 44 is constituted by a plurality of arrayed second pixels, wherein the second image 44 has X₂ columns of the second pixels along the first coordinate axis direction (for example, horizontal direction), and the second image 44 has Y₂ rows of the second pixels along the second coordinate axis direction (for example, vertical direction). The method comprises the following steps:

(a) capturing the first pixels of the first image 42;

(b) determining a difference value of column and a difference value of row, wherein the difference value of column is derived from subtracting the number of the columns of the first image 42 enlarged in an integer multiple from the number of the columns (X₂) of the second image 44. The difference value of row is derived from subtracting the number of the rows of the first image 42 enlarged in the integer multiple from the number of the rows (Y₂) of the second image 44, wherein the integer multiple is smaller than the non-integer multiple and is closest to the non-integer multiple. For example, the first image 42 is enlarged into a temporary image 43 that is smaller than and is closest to the second image 44 in an

integer multiple n, wherein the difference value of column between the temporary image 43 and the second image 44 is X₃, and the difference value of row between the temporary image 43 and the second image 44 is Y₃;

(c) determining at least one repeatedly display column 421 according to the difference value of column. For example, the X₃ columns of the difference columns are distributed equally among the X₁ columns of the first image 42, wherein d=X₁/X₃, d is an integer, and the (d−1)th, (2d−1)th, (3d−1)th, . . . , (nd−1)th columns are repeatedly displayed columns 421;

(d) determining at least one repeatedly displayed row 422 according to the difference value of row. For example, the Y₃ rows of the difference rows are distributed equally among the Y₁, columns of the first image 42 to determine the repeatedly displayed columns 421; and

(e) repeating the repeatedly displayed column 421 and repeatedly displayed row 422 of the first image 42 in a multiple of the integer multiple with an increment of 1, and repeating the other columns and rows of the first image 42 in the integer multiple to form the second image 44. That is, the repeatedly displayed columns 421 and repeatedly displayed rows 422 are enlarged in n+1 multiple, and other columns and rows are enlarged in n multiple.

### EXAMPLE 3

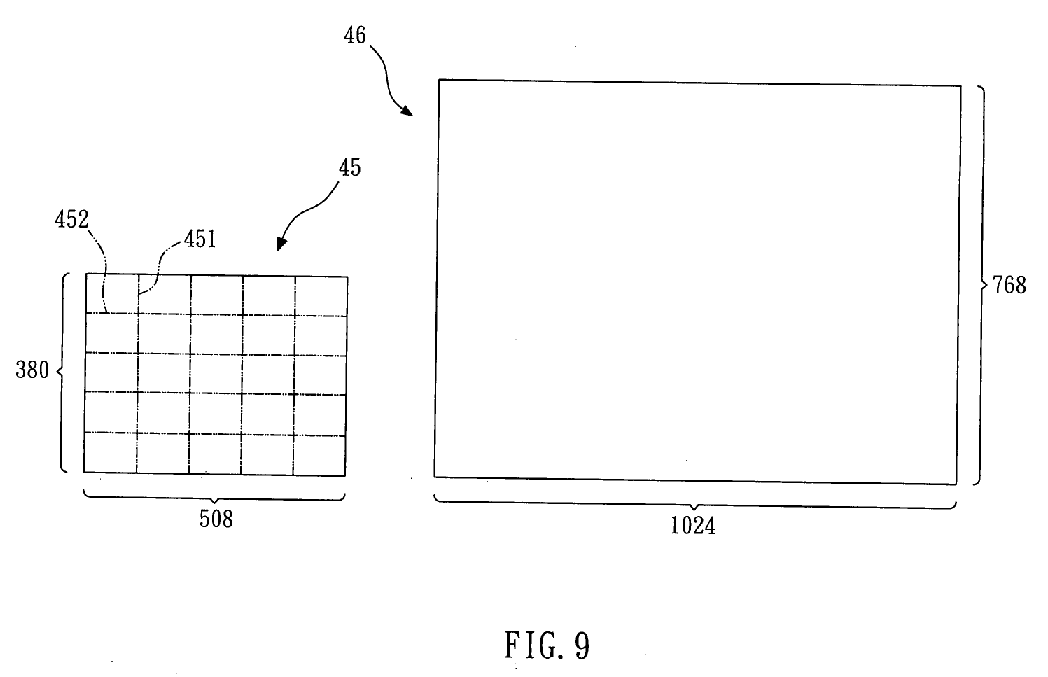

FIG. 9 shows the image enlarging method according to example 3 of the present invention. The image enlarging method of example 3 is used for enlarging a first image 45 into a second image 46 in a non-integer multiple. The first image 45 is constituted by a plurality of arrayed first pixels, and has a resolution of 507*379, that is, the first image 45 has 507 columns of first pixels and 379 rows of first pixels. The second image 46 is constituted by a plurality of arrayed second pixels, and has a resolution of 1024*768, that is, the second image 46 has 1024 columns of second pixels and 768 rows of second pixels.

After the first image 45 is enlarged in a multiple of 2 along the horizontal direction and the vertical direction, its resolution is only 1014*758. The difference value of column is 10 in the horizontal direction, and the difference value of row is 10 in the vertical direction.

Then, the 10 columns of the difference columns are distributed equally among the columns of the first image 42 to determine repeatedly displayed column 451. First, the interval d₁ between two repeatedlyed display columns 451 is determined by 507/10=50.7, but d₁ must be an integer. Therefore, d₁ is 50. Accordingly, the 49^{th} column (50-1), 99^{th} column (2*50-1), 149^{th} column (3*50-1), 199^{th} column (4*50-1), 249^{th} column (5*50-1), 299^{th} column (6*50-1), 349^{th} column (7*50-1), 399^{th} column (8*50-1), 449^{th} column (9*50-1), and 499^{th} column (10*50-1) are repeatedly displayed columns 451.

Then, the 10 rows of the difference rows are distributed equally among the columns of the first image 42 to determine repeatedly displayed rows 452. First, the interval d₂ between two repeatedly displayed rows 451 is determined by 379/10=37.9, but d₂ must be an integer. Therefore, d₂ is 37. Accordingly, the 36^{th} row (37-1), 73rd row (2*37-1), 110^{th} row (3*37-1), 147^{th} row (4*37-1), 184^{th} row (5*37-1), 221^{st} row (6*37-1), 258^{th} row (7*37-1), 295^{th} row (8*37-1), 332^{nd} row (9*37-1), and 369^{th} row (10*37-1) are repeatedly displayed rows 452.

Finally, the second image 46 is displayed, wherein the repeatedly displayed columns 451 and repeatedly displayed rows 452 of the first image 42 are enlarged in a multiple of 3. That is, the repeatedly display columns 451 and repeatedly display rows 452 are displayed repeatedly 3 times, i.e., the integer multiple 2 adds 1. The other columns and rows are enlarged in a multiple of 2. That is, the other columns and rows are displayed repeatedly 2 times, i.e., the integer multiple 2.

The present invention also relates to an image enlarging device for enlarging a first image into a second image in a non-integer multiple. The first image is constituted by a plurality of arrayed first pixels, wherein the first image has a plurality of columns of the first pixels along a first coordinate axis direction, and the first image has a plurality of rows of the first pixels along a second coordinate axis direction. The second image is constituted by a plurality of arrayed second pixels, wherein the second image has a plurality of columns of the second pixels along the first coordinate axis direction, and the second image has a plurality of rows of the second pixels along the second coordinate axis direction. The image enlarging device comprises: a capture device, a DDA device and a display device. The capture device is used for capturing the first pixels of the first image. The DDA device is used for executing a DDA algorithm-based process so as to determine the display information of the second pixels of the second image according to the first pixels of the first image. The display device is used for displaying the second image.

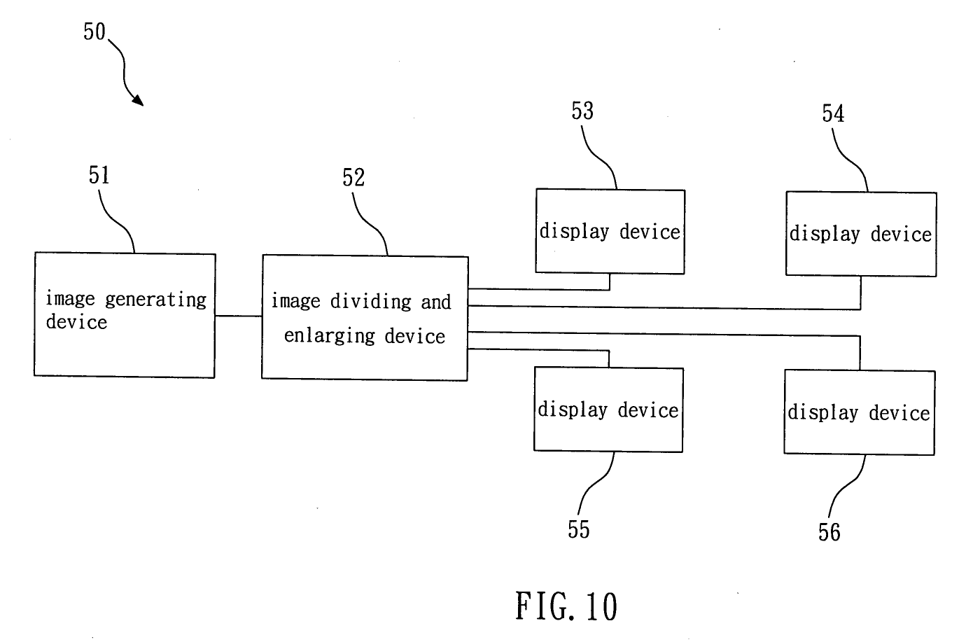

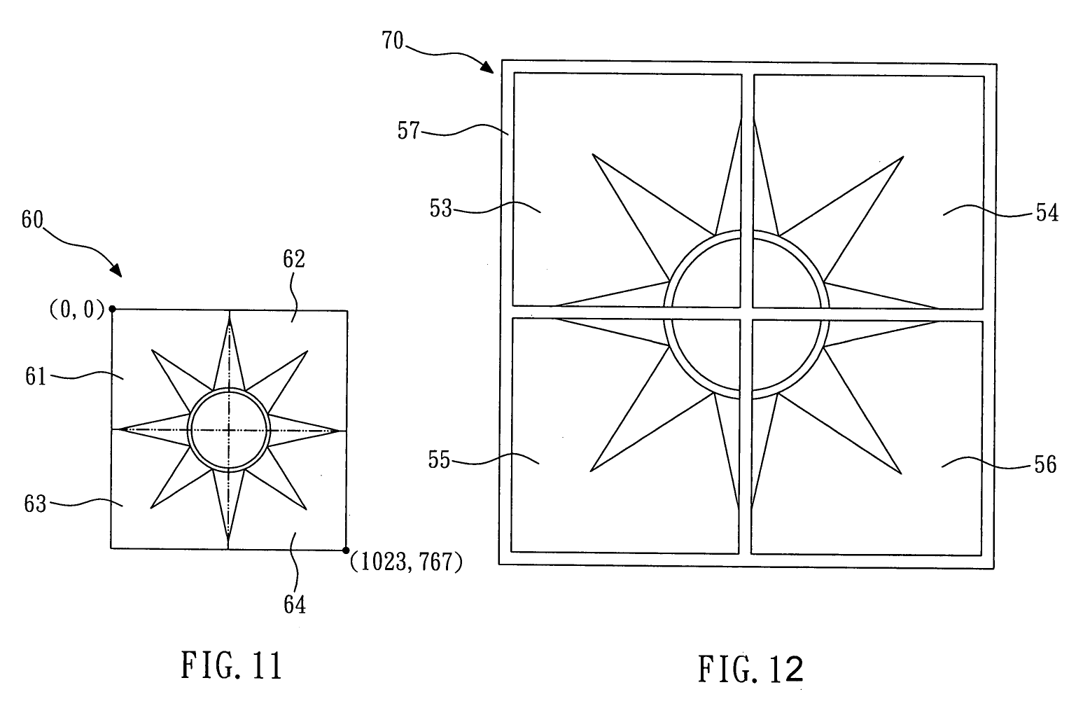

FIG. 10 shows a preferred embodiment of a TV wall system according to the present invention. The TV wall system 50 comprises: a plurality of arrayed display devices 53, 54, 55, 56, an image generating device 51 and an image dividing and enlarging device 52. The image generating device 51 is used for providing a source image 60 (FIG. 11) that is to be enlarged into an enlarged image 70 (FIG. 12) that is displayed on the TV wall system 50. The image generating device 51 may be any kind of players that can generate images, including but not limited to DVD player, VCD player, computer or demodulator.

FIGS. 11 and 12 show a source image 60 and an enlarged image 70 applied for the embodiment of FIG. 10, respectively. The source image 60 is enlarged into the enlarged image 70 in a multiple of 4 (2*2) and displayed on the display devices 53, 54, 55, 56 of the TV wall. In the embodiment, the resolutions of the source image 60 and single display device are both 1024*768.

The image dividing and enlarging device 52 is used for processing the source image 60 and transmitting to the display devices 53, 54, 55, 56 to display the enlarged image 70. The process is as follows.

First, the source image 60 is stored in a memory device (not shown). The memory device may be in the image dividing and enlarging device 52 or an independent device. The memory device can store the full-size image or partition image, which depends on the set up of the parameters. In the embodiment, the full-size source image 60 is stored and is divided into four partitions 61, 62, 63, 64, wherein the partition 61 corresponds to the display device 53, the partition 62 corresponds to the display device 54, the partition 63 corresponds to the display device 55 and the partition 64 corresponds to the display device 56.

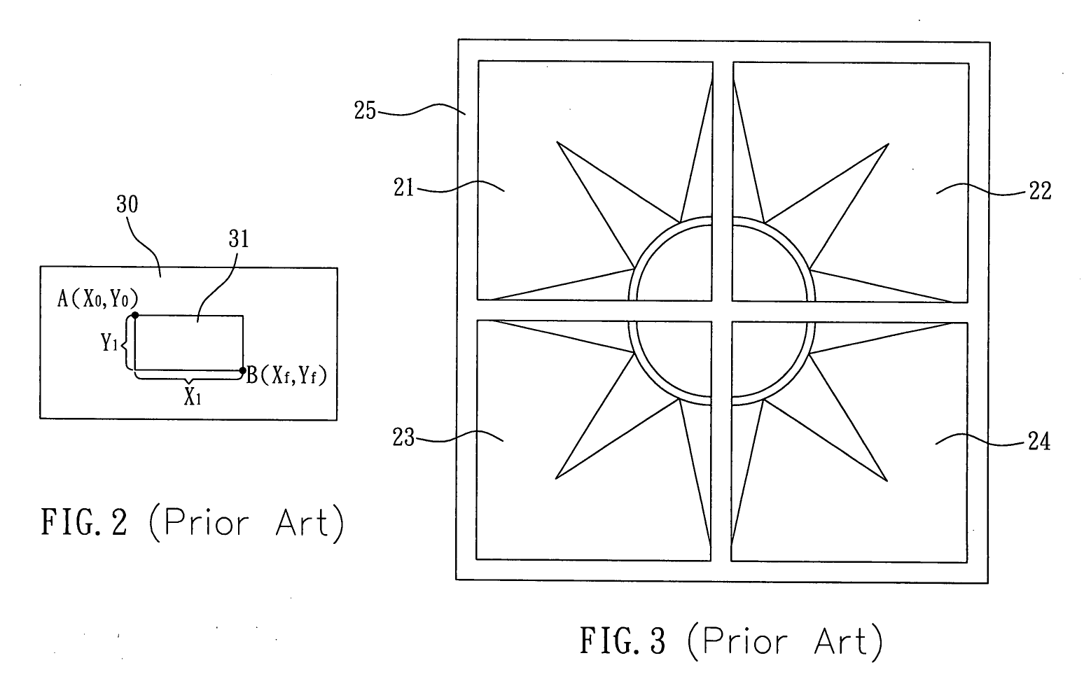

Then, the images stored in the memory device are captured out. There are two ways, as shown in FIG. 2, for defining the parameters of capture: the first way is defining the image from an initial point on the upper-left corner to an end point on the lower-right corner; the second way is defining the image by the initial point, a horizontal length and a vertical length. In the present invention, when capturing the image, the amount and disposition of the display devices 53, 54, 55, 56 and the discard of the frame between the display devices 53, 54, 55, 56 must be considered.

In the embodiment, the frame 57 of the enlarged image 70 covers 10 columns of pixels and 10 rows of pixels. The partition 61 is captured from (0, 0) to (506, 378), the partition 62 is captured from (517, 0) to (1023, 378), the partition 63 is captured from (0, 389) to (506, 767), and the partition 64 is captured from (517, 389) to (1023, 767). However, taking the partition 61 for example, when it is displayed on the display device 53, it lacks 10 columns of pixels along the horizontal direction and 10 rows of pixels along the vertical direction if it is enlarged in a multiple of 2 along the horizontal direction and the vertical direction since the resolution of the enlarged partition 61 is 1014*758.

Then, the images of the partitions 61, 62, 63, 64 are enlarged into plural second images in a non-integer multiple respectively. The image enlarging method is the same as the above-mentioned first to third embodiments.

Finally, the second images are displayed on the display devices 53, 54, 55, 56 which are connected to the image dividing and enlarging device 52 so as to combine an enlarged image 70. Each of the display devices 53, 54, 55, 56 receives and displays one single image, and does not need to have the function of enlarging or dividing image.

Comparing FIG. 12 with FIG. 3, the enlarged image 70 formed by the present invention has no distortion that occurrs in the enlarged image formed by the conventional method, and enlarged image 70 has no black area on the sides thereof.

While several embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. An image enlarging method for enlarging a first image into a second image in a non-integer multiple, the first image being constituted by a plurality of arrayed first pixels, wherein the first image has plural column first pixels arranged in plural columns along a first coordinate axis direction, and the first image has plural row first pixels arranged in plural rows along a second coordinate axis direction; the second image being constituted by a plurality of arrayed second pixels, wherein the second image has plural column second pixels arranged in plural columns along the first coordinate axis direction, and the second image has plural row second pixels arranged in plural rows along the second coordinate axis direction, the method comprising the following steps:
(a) capturing the first pixels of the first image;
(b) determining the column second pixels of the second image according to the column first pixels of the first image along the first coordinate axis direction by utilizing a Digital Differential Analysis (DDA) algorithm-based process so as to form a temporary image, wherein the temporary image has plural column temporary pixels arranged in plural columns along the first coordinate axis direction, and the temporary image has plural row temporary pixels arranged in plural rows along the second coordinate axis direction; and
(c) determining the row second pixels of the second image according to the row temporary pixels along the second coordinate axis direction by utilizing the DDA algorithm-based process so as to form the second image.

2. The method according to claim 1, wherein the first image has X₁ columns of the first pixels and Y₁, rows of the first pixels, the second image has X₂ columns of the second pixels and Y₂ rows of the second pixels, and the step (b) comprises the following steps:
(b1) equalizing the column temporary pixels of a predetermined column of the temporary image to the column first pixels of a corresponding column of the first image;
(b2) accumulating the X₁ value and a first temporary value to form a second temporary value;
(b3) determining whether or not the second temporary value is smaller than the X₂ value in order to determine the column temporary pixels of a next column next to the predetermined column;
(b4) equalizing the column temporary pixels of the next column next to the predetermined column to the column temporary pixels of the predetermined column, and changing the first temporary value to the second temporary value, if the second temporary value is smaller than the X₂ value, which is defined as a non-carry situation; and
(b5) equalizing the column temporary pixels of the next column next to the predetermined column to the column first pixels of a next column next to the corresponding column of the first pixels of the first image, then forming a third temporary value by subtracting the X₂ value from the second temporary value, and changing the first temporary value to the third temporary value, if the second temporary value is larger than or equal to the X₂ value, which is defined as a carry situation.

3. The method according to claim 2, wherein the step (c) comprises the following steps:
(c1) equalizing the row second pixels of a predetermined row of the second image to the row temporary pixels of a corresponding row of the temporary image;
(c2) accumulating the Y₁ value and a fourth temporary value to form a fifth temporary value;
(c3) determining whether or not the fifth temporary value is smaller than the Y₂ value in order to determine the row second pixels of a next row next to the predetermined row;
(c4) equalizing the row second pixels of the next row next to the predetermined row to the row second pixels of the predetermined row, and changing the fourth temporary value to the fifth temporary value, if the fifth temporary value is smaller than the Y₂ value, which is defined as a non-carry situation; and
(c5) equalizing the row second pixels of the next row next to the predetermined row to the row temporary pixels of a next row next to the corresponding row of the temporary pixels of the temporary image, then forming a sixth temporary value by subtracting the Y₂ value from the fifth temporary value, and changing the fourth temporary value to the sixth temporary value, if the fifth temporary value is larger than or equal to the Y₂ value, which is defined as a carry situation.

4. An image enlarging method for enlarging a first image into a second image in a non-integer multiple, the first image being constituted by a plurality of arrayed first pixels, wherein the first image has plural the first pixels along a first coordinate axis direction, and the first image has plural the first pixels along a second coordinate axis direction; the second image being constituted by a plurality of arrayed second pixels, wherein the second image has plural the second pixels along the first coordinate axis direction, and the second image has plural the second pixels along the second coordinate axis direction, the method comprising the following steps:
(a) capturing the first pixels of the first image, each first pixel being defined a first coordinate value, a second coordinate value and a first pixel value, wherein the first coordinate value corresponds to the first coordinate axis direction, and the second coordinate value corresponds to the second coordinate axis direction;
(b) determining first coordinate values of the second pixels of the second image according to the first coordinate values of the first pixels by utilizing a DDA algorithm-based process;
(c) determining second coordinate values of the second pixels of the second image according to the second coordinate values of the first pixels by utilizing the DDA algorithm-based process; and
(d) specifying second pixel values of the second pixels according to the first coordinate values and the second coordinate values of the second pixels, wherein the second pixel values of the second pixels are the same as the first pixel values of the first pixels having the same first coordinate values and the second coordinate values with the second pixels.

5. The method according to claim 4, wherein the first image has X₁ columns of the first pixels and Y₁ rows of the first pixels along the first and the second coordinate axis direction, respectively, the second image has X₂ columns of the second pixels and Y₂ rows of the second pixels along the first and the second coordinate axis direction, respectively, and the step (b) comprises the following steps:
(b1) equalizing a first coordinate value of a predetermined second pixel of the second image to a first coordinate value of a corresponding first pixel of the first image;
(b2) accumulating the X₁ value and a first temporary value to form a second temporary value;
(b3) determining whether or not the second temporary value is smaller than the X₂ value in order to determine a first coordinate value of a next second pixel next to the predetermined second pixel;
(b4) equalizing the first coordinate value of the next second pixel next to the predetermined second pixel to the first coordinate value of the predetermined second pixel, and changing the first temporary value to the second temporary value, if the second temporary value is smaller than the X₂ value, which is defined as a non-carry situation; and
(b5) equalizing the first coordinate value of the next second pixel next to the predetermined second pixel to the first coordinate value of the predetermined second pixel with an increment of 1, then forming a third temporary value by subtracting the X₂ value from the second temporary value, and changing the first temporary value to the third temporary value, if the second temporary value is larger than or equal to the X₂ value, which is defined as carry situation.

6. The method according to claim 4, wherein the first image has X₁ columns of the first pixels and Y₁ rows of the first pixels along the first and the second coordinate axis direction, respectively, the second image has X₂ columns of the second pixels and Y₂ rows of the second pixels along the first and the second coordinate axis direction, respectively, and the step (c) comprises the following steps:
(c1) equalizing a second coordinate value of a predetermined second pixel of the second image to a second coordinate value of a corresponding first pixel of the first image;
(c2) accumulating the Y₁ value and a fourth temporary value to form a fifth temporary value;
(c3) determining whether or not the fifth temporary value is smaller than the Y₂ value in order to determine a second coordinate value of a next second pixel next to the predetermined second pixel;
(c4) equalizing the second coordinate value of the next second pixel next to the predetermined second pixel to the second coordinate value of the predetermined second pixel, and changing the fourth temporary value to the fifth temporary value, if the fifth temporary value is smaller than the Y₂ value, which is defined as a non-carry situation; and
(c5) equalizing the second coordinate value of the next second pixel next to the predetermined second pixel to the second coordinate value of the predetermined second pixel with an increment of 1, then forming a sixth temporary value by subtracting the Y₂ value from the fifth temporary value, and changing the fourth temporary value to the sixth temporary value, if the fifth temporary value is larger than or equal to the Y₂ value, which is defined as a carry situation.

7. An image enlarging method for enlarging a first image into a second image in a non-integer multiple, the first image being constituted by a plurality of arrayed first pixels, wherein the first image has plural columns of the first pixels along a first coordinate axis direction, and the first image has plural rows of the first pixels along a second coordinate axis direction; the second image being constituted by a plurality of arrayed second pixels, wherein the second image has plural columns of the second pixels along the first coordinate axis direction, and the second image has plural rows of the second pixels along the second coordinate axis direction, the method comprising the following steps:
(a) capturing the first pixels of the first image;
(b) determining a difference value of column and a difference value of row, wherein the difference value of column is derived from subtracting the number of the columns of the first image enlarged in an integer multiple from the number of the columns of the second image, and the difference value of row is derived from subtracting the number of the rows of the first image enlarged in the integer multiple from the number of the rows of the second image, wherein the integer multiple is smaller than the non-integer multiple and is closest to the non-integer multiple most;
(c) determining at least one repeatedly displayed column according to the difference value of column;
(d) determining at least one repeatedly displayed row according to the difference value of row; and
(e) repeating the repeatedly displayed column and repeatedly displayed row in a multiple of the integer multiple with an increment of 1, and repeating the other columns and rows in the integer multiple to form the second image.

8. The method according to claim 7, wherein the repeatedly displayed columns are distributed equally among the columns of the first image in step (c).

9. The method according to claim 7, wherein the repeatedly displayed rows are distributed equally among the rows of the first image in step (d).

10. A method for forming an enlarged image on a TV wall having a plurality of display devices, the method comprising the following steps:
(a) capturing a source image;
(b) dividing the source image into a plurality of first images according to the amount and disposition of the display devices and the discard of the frame between the display devices, and determining a non-integer multiple;
(c) enlarging the first images into a plurality of second images in a non-integer multiple; and
(d) displaying the second images on the corresponding display devices respectively.

11. The method according to claim 10, wherein the first image is constituted by a plurality of arrayed first pixels, the first image has plural column first pixels arranged in plural columns along a first coordinate axis direction, and the first image has plural row first pixels arranged in plural rows along a second coordinate axis direction; the second image is constituted by a plurality of arrayed second pixels, the second image has plural column second pixels arranged in plural columns along the first coordinate axis direction, and the second image has plural row second pixels arranged in plural rows along the second coordinate axis direction, the step (c) comprises the following steps:
(c1) capturing the first pixels of the first image;
(c2) determining the column second pixels of the second image according to the column first pixels of the first image along the first coordinate axis direction by utilizing a Digital Differential Analysis (DDA) algorithm-based process so as to form a temporary image, wherein the temporary image has plural column temporary pixels arranged in plural columns along the first coordinate axis direction, and the temporary image has plural row temporary pixels arranged in plural rows along the second coordinate axis direction; and
(c3) determining the row second pixels of the second image according to the row temporary pixels along the second coordinate axis direction by utilizing the DDA algorithm-based process so as to form the second image.

12. The method according to claim 10, wherein the first image is constituted by a plurality of arrayed first pixels, the first image has plural the first pixels along a first coordinate axis direction, and the first image has plural the first pixels along a second coordinate axis direction; the second image is constituted by a plurality of arrayed second pixels, wherein the second image has plural the second pixels along the first coordinate axis direction, and the second image has plural the second pixels along the second coordinate axis direction, the step (c) comprises the following steps:
(c1) capturing the first pixels of the first image, each first pixel being defined a first coordinate value, a second coordinate value and a first pixel value, wherein the first coordinate value corresponds to the first coordinate axis direction, and the second coordinate value corresponds to the second coordinate axis direction;
(c2) determining first coordinate values of the second pixels of the second image according to the first coordinate values of the first pixels by utilizing a DDA algorithm-based process;
(c3) determining second coordinate values of the second pixels of the second image according to the second coordinate values of the first pixels by utilizing the DDA algorithm-based process; and
(c4) specifying second pixel values of the second pixels according to the first coordinate values and the second coordinate values of the second pixels, wherein the second pixel values of the second pixels are the same as the first pixel values of the first pixels having the same first coordinate values and the second coordinate values with the second pixels.

13. The method according to claim 10, wherein the first image is constituted by a plurality of arrayed first pixels, the first image has plural columns of the first pixels along a first coordinate axis direction, and the first image has plural rows of the first pixels along a second coordinate axis direction; the second image is constituted by a plurality of arrayed second pixels, wherein the second image has plural columns of the second pixels along the first coordinate axis direction, and the second image has plural rows of the second pixels along the second coordinate axis direction, the step (c) comprises the following steps:
(c1) capturing the first pixels of the first image;
(c2) determining a difference value of column and a difference value of row, wherein the difference value of column is derived from subtracting the number of the columns of the first image enlarged in an integer multiple from the number of the columns of the second image, and the difference value of row is derived from subtracting the number of the rows of the first image enlarged in the integer multiple from the number of the rows of the second image, wherein the integer multiple is smaller than the non-integer multiple and is closest to the non-integer multiple;
(c3) determining at least one repeatedly displayed column according to the difference value of column;
(c4) determining at least one repeatedly displayed row according to the difference value of row; and
(c5) repeating the repeatedly displayed column and repeatedly displayed row in a multiple of the integer multiple with an increment of 1, and repeating the other columns and rows in the integer multiple to form the second image.

14. An image enlarging device for enlarging a first image into a second image in a non-integer multiple, the first image being constituted by a plurality of arrayed first pixels, and the second image being constituted by a plurality of arrayed second pixels, the image enlarging device comprising:
a capture device for capturing the first pixels of the first image;
a DDA device for executing a DDA algorithm-based process so as to determine the display information of the second pixels of the second image according to the first pixels of the first image; and
a display device for displaying the second image.

15. A TV wall system comprising:
a plurality of arrayed display devices;
an image generating device for providing a source image;
an image dividing and enlarging device for dividing the source image into a plurality of first images according to the amount and disposition of the display devices and the discard of the frame between the display devices, and enlarging the first images into a plurality of second images in a non-integer multiple, the image dividing and enlarging device being connected to the display devices so as to display the second images on the corresponding display devices respectively.
